(19) United States
(12) Patent Application Publication
(10) Pub. No.: US 2020/0407647 A1
(43) Pub. Date: Dec. 31, 2020

(54) Heavy Oils Having Reduced Total Acid Number and Olefin Content

(71) Applicants: Soumaine Dehkissia, Sherbrooke (CA); Christos Chronopoulos, Sherbrooke (CA); Michel Chomet, Sherwood Park (CA); Jean Frechette, Sherbrooke (CA)

(72) Inventors: Soumaine Dehkissia, Sherbrooke (CA); Christos Chronopoulos, Sherbrooke (CA); Michel Chomet, Sherwood Park (CA); Jean Frechette, Sherbrooke (CA)

(21) Appl. No.: 17/015,498

(22) Filed: Sep. 9, 2020

Related U.S. Application Data
(63) Continuation of application No. 16/248,166, filed on Jan. 15, 2019, now abandoned.
Application No. 16/248,166 is a continuation of application No. 14/451,787, filed on Aug. 5, 2014, now abandoned.
(60) Provisional application No. 61/864,118, filed on Aug. 9, 2013.

(51) Int. Cl. C10G 31/06; C10G 67/02; C10G 55/04; C10G 53/02; C10G 67/14; C10G 3/00; C10G 9/00

(52) U.S. Cl. CPC C10G 31/06; C10G 67/02; C10G 55/04; C10G 53/02; Y02P 30/20; C10G 3/40; C10G 9/007; C10G 2300/203; C10G 2300/308; C10G 67/14

(57) ABSTRACT

A process for treating a heavy oil by heating a feedstock comprising a heavy oil in order to separate from the heavy oil a first fraction. The first fraction contains no more than 25% of the total number of acid groups of the heavy oil. A second fraction contains at least 75% of the total number of acid groups of the heavy oil. The second fraction then is treated under conditions that provide a heavy oil that has a total acid number, or TAN, that does not exceed 1.0 mg KOH/g, or is at least 50% lower than the total acid number prior to treatment, an olefin content that does not exceed 1.0 wt. %, and a p-value of at least 50% of the p-value of the heavy oil prior to treatment, or a p-value that is at least 1.5.

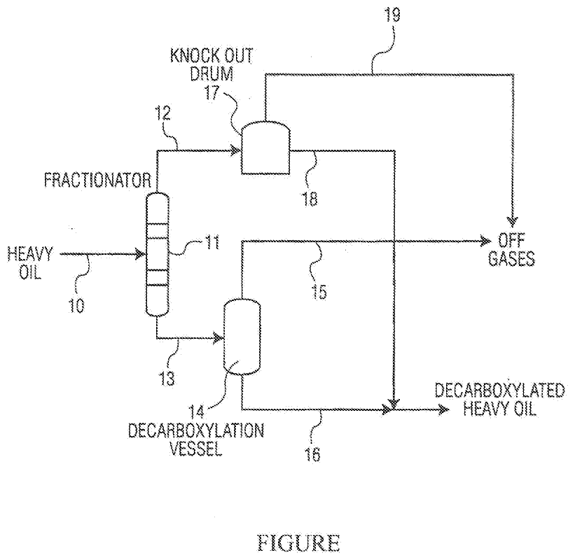

This application is a Continuation of application Ser. No. 16/248,166, filed Jan. 15, 2019, which is a Continuation of application Ser. No. 14/451,787, filed Aug. 5, 2014, which claims priority based on provisional Application Ser. No. 61/864,118, filed Aug. 9, 2013, the contents of which are incorporated by reference in their entireties.

This invention relates to the treatment of heavy oils. More particularly, this invention relates to treating heavy oils to provide a stable treated heavy oil having a total acid number (TAN) that does not exceed 1.0 mg KOH/g, or is at least 50% lower than the total acid number (TAN) prior to treatment, while having an olefin content that does not exceed 1.0 wt. %, and a p-value which is at least 50% of the p-value of the heavy oil prior to treatment, or is at least 1.5. The treated heavy oil also may have an API gravity which is no more than 0.5° greater than the API gravity of the heavy oil prior to treatment. The treatment may be performed in the absence of a stripping gas. Such treatment also may be performed without adding hydrogen to the heavy oil.

The term “heavy oil”, as used herein, includes oils which are classified by the American Petroleum Institute (API), as heavy oils or extra heavy oils, as well as blended oils such as dilbit (a diluent-bitumen blend) or synbit (a synthetic oil-bitumen blend). In general, a heavy hydrocarbon oil has an API gravity between 22.3° (density of 920 kg/m³ or 0.920 g/cm³) and 10.0° (density of 1,000 kg/m³ or 1 g/cm³). An extra heavy oil in general has an API gravity of less than 10.0° (density greater than 1,000 kg/m³ or greater than 1 g/cm³). For example, heavy oils may be extracted from oil sands, atmospheric tar bottoms products, vacuum tar bottoms products, shale oils, coal-derived liquids, crude oil residues, and topped crude oils.

Heavy oils contain high molecular weight compounds known as asphaltenes, as well as organic compounds containing acidic groups (e.g., carboxylic acid or —COOH groups), such as naphthenic acids, and metals such as nickel and vanadium.

The carboxylic acid groups in acidic organic molecules cause corrosion, and heavy oil refineries discount the value of heavy oils having high acidity levels. The asphaltenes may cause fouling in visbreaking, and may cause fouling in refinery heat exchangers and burners.

The total acid number, or TAN, is an indicator of the acidity, mainly in the form of naphthenic acids, present in heavy oils. Naphthenic acids include a cyclic core with no double bonds between the carbon atoms, and one or more alkyl groups attached to the cyclic naphthenic core. One or more of the alkyl groups attached to the naphthenic core has a terminal carboxylic acid (—COOH) group. A typical naphthenic acid group has a carbon backbone of 9 to 20 carbon atoms. The backbone contains at least one naphthenic ring (Cyclopentane is the most common.) to which are attached alkyl groups. One or two of the alkyl groups have a terminal carboxylic acid group. These terminal carboxylic acid group(s) are responsible primarily for the corrosion that may be caused by heavy oils.

The total acid number, or TAN, is determined by a neutralization test using potassium hydroxide, or KOH. The TAN is measured, in general, as the number of milligrams of KOH needed to neutralize 1 gram of oil following an established standardized methodology known as ASTM-D664. It is desirable that the TAN for heavy oil does not exceed 1.0 mg KOH/g. In general, the values of heavy oils having a TAN that is greater than 1.0 mg KOH/g are discounted.

Although heavy oils can be treated, such as by heating, for example, in order to reduce the TAN, such treatments result in the production of other undesirable components, such as olefins, and an increase in the tendency of the asphaltenes to precipitate. For example, such treatments may reduce the TAN of the heavy oil, but increase the olefin content of the heavy oil to unacceptable levels, and increase the tendency of the asphaltenes to precipitate, as shown by decreased peptization values, or p-values, whereby such heavy oils are less than stable.

Olefin content can be measured by the bromine number test or by the proton Nuclear Magnetic Resonance Spectroscopy (HNMR) test. The bromine number is the amount of bromine (in grams) absorbed by 100 grams of a sample. The bromine number is measured according to the ASTM-D1159 procedure. The number indicates the degree of unsaturation, which is related to olefin content. A bromine number under 10 is considered acceptable for normal crude oil handling. The HNMR test measures olefin content on the full crude by mass as 1-decene equivalent. A test result that is greater than 1.0% olefin by mass as 1-decene equivalent indicates the presence of an unacceptable amount of olefins. A bromine number of 10 corresponds generally to an olefin content of 1.0% by weight. With respect to the transportation of heavy oils, the olefin content of the heavy oil should not exceed 1.0% by weight, as measured by the HNMR test or the bromine number test, for example.

The p-value of a heavy oil is a measure of the flocculation potential of asphaltenes and their tendency to form solid deposits. The p-value is a stability indicator and also is a measure of asphaltene solubility. The p-value is determined by testing the heavy oil according to the ASTM-D7157 method or a method similar to ASTM D-7157, and ranges from 1 (unstable) to 5 (very stable). The method consists of solubilizing three samples of the heavy oil using different amounts of toluene or xylenes. These three different mixtures of heavy oil samples and aromatic solvent (i.e., toluene or xylene) then are titrated with a paraffinic solvent, such as n-heptane, to precipitate the asphaltenes. The amounts of heavy oil and solvents added, including the titration solvent, up to the onset of the peptization of the asphaltenes, are used to calculate the stability parameters and their intrinsic stability. A p-value which is at least 1.5 indicates that the heavy oil is stable, while a heavy oil having a p-value of less than 1.5 generally is considered unstable.

It therefore is an object of the present invention to provide a treated heavy oil having a reduced total acid number, as well as an acceptable olefin content and p-value. Such treated heavy oil also may have a small increase or no increase in density, as compared to the heavy oil prior to treatment.

In accordance with an aspect of the present invention, there is provided a process for treating a heavy oil. The process comprises, in a first step, heating a feedstock comprising a heavy oil to remove a first, or light, fraction from the heavy oil. The first fraction contains no more than 25% of the total number of acid groups of the heavy oil. The first, or light, fraction, in general contains TAN reduction inhibitors such as water vapor or other incondensable gases, and thus the first step removes those inhibitors. Thus, there also is provided a second fraction. The second fraction contains at least 75% of the total number of acid groups of the heavy oil. The second fraction then is treated, in a second step, under conditions that provide a treated heavy oil that has a total acid number (TAN) that does not exceed 1.0 mg KOH/g, or is at least 50% lower than the total acid number (TAN) of the heavy oil prior to the treatment of the heavy oil. The treated heavy oil also has an olefin content that does not exceed 1.0 wt. %, and a p-value that is at least 50% of the p-value of the heavy oil prior to the treatment of the heavy oil, or a p-value of at least 1.5.

In a non-limiting embodiment, the treated heavy oil has a p-value that is at least 75% of the p-value of the heavy oil prior to the treatment of the heavy oil, or a p-value of at least 2.0.

In a non-limiting embodiment, the treated heavy oil has a density, as measured by API gravity, that is slightly greater or no greater than that of the heavy oil prior to treatment. In one non-limiting embodiment, the treated heavy oil has an API gravity which is no more than 0.5° greater than the heavy oil prior to treatment. In another non-limiting embodiment, the treated heavy oil has an API gravity which is no more than 0.2° greater than the heavy oil prior to treatment. In yet another non-limiting embodiment, the treated heavy oil has an API gravity which is no more than 0.1° greater than the heavy oil prior to treatment.

In a non-limiting embodiment, a total acid number, or TAN, profile of the heavy oil is determined first by measuring the TAN of the heavy oil prior to treating the heavy oil. A sample of the heavy oil then is distilled at various temperatures, and the TAN of each distilled fraction is determined. From the TAN values of each distilled fraction of the heavy oil, one can determine the temperature of the heavy oil at which components that boil below such temperature will contain no more than 25% of the total number of acid groups of such heavy oil, and at which components that boil at or above such temperature contain at least 75% of the total number of acid groups of the heavy oil.

In many cases, the first fraction, which contains no more than 25% of the total number of acid groups of the heavy oil, includes components which boil at a temperature no greater than 250° C. to 300° C. atmospheric equivalent temperature (AET), while the second fraction, which contains at least 75% of the total number of acid groups of the heavy oil, includes components which boil at a temperature at least 250° C. to 300° C. atmospheric equivalent temperature (AET).

In a non-limiting embodiment, the first fraction contains no more than 10% of the total acid groups of the heavy oil, and the second fraction contains at least 90% of the total acid groups of the heavy oil. In another non-limiting embodiment, the first fraction contains no more than 5% of the total acid groups of the heavy oil, and the second fraction contains at least 95% of the total acid groups of the heavy oil. In yet another non-limiting embodiment, the first fraction contains no more than 3% of the total acid groups of the heavy oil, and the second fraction contains at least 97% of the total acid groups of the heavy oil.

Although the scope of the present invention is not intended to be limited to any theoretical reasoning, it is believed that, when a heavy oil is treated, such as by heating the heavy oil, in order to reduce the total acid number (TAN) of the heavy oil, that the lower-boiling components, i.e., components that in general contain small amounts of acid groups, can contain water vapor or other compounds which could inhibit or reduce the rate of decarboxylation of acidic components, such as the naphthenic acids. By removing such components prior to treating the heavy oil, the heavy oil can be treated to reduce the total acid number (TAN) more efficiently. Also, low boiling components in the heavy oil generally are saturated compounds that are not miscible easily with the asphaltenes in the heavy oil, and decrease the oil's stability. By removing the lighter fraction, the stability of the heavy oil is improved, and further TAN reduction is accomplished with the maintenance of acceptable olefin levels, and such further TAN reduction of the heavy oil is not inhibited by water vapor.

In a non-limiting embodiment, the first step comprises separating the first fraction, which contains no more than 25% of the total acid groups, by heating the feedstock comprising the heavy oil to a temperature that does not exceed 350° C. atmospheric equivalent temperature (AET) to avoid thermal cracking, which for hydrocarbons occurs generally around 370° C. AET, and subjecting the feedstock comprising a heavy oil to a pressure that does not exceed 3 atm.

In another non-limiting embodiment, the second step comprises heating the second fraction to a temperature that does not exceed 400° C. atmospheric equivalent temperature (AET), and subjecting the second fraction to a pressure that does not exceed 1 atm. In another non-limiting embodiment, the second step comprises heating the second fraction to a temperature that does not exceed 385° C. atmospheric equivalent temperature (AET), and subjecting the second fraction to a pressure that does not exceed 1 atm. In yet another non-limiting embodiment, the second step comprises heating the second fraction to a temperature that does not exceed 380° C. atmospheric equivalent temperature (AET), and subjecting the second fraction to a pressure that does not exceed 1 atm.

In one non-limiting embodiment, prior to removing the first fraction from the feedstock comprising a heavy oil, the feedstock is heated to a temperature that does not exceed 100° C. (AET), thereby removing light components having a boiling point of less than 100° C. (AET) from the heavy oil. In general, such components having a boiling point of less than 100° C. (AET) may be solvents and/or diluents.

In another non-limiting embodiment, in the first step, the feedstock comprising a heavy oil is heated to a temperature that does not exceed 350° C. (AET) and a pressure that does not exceed 500 mmHg.

In another non-limiting embodiment, the second fraction, in the second step, is heated to a temperature that does not exceed 400° C. (AET) and a pressure that does not exceed 500 mmHg. In yet another non-limiting embodiment, the second fraction, in the second step, is heated to a temperature of from about 350° C. (AET) to a temperature that does not exceed 400° C. (AET).

In a further non-limiting embodiment, the second fraction, in the second step, is heated to a temperature that does not exceed 400° C. (AET) and is subjected to a pressure that does not exceed 1 atm for a period of time of from about 1 minute to about 60 minutes. In yet another non-limiting embodiment, the second fraction, in the second step, is subjected to a temperature that does not exceed 490° C. (AET) and is subjected to a pressure that does not exceed 1 atm for a period of time of from about 20 minutes to about 35 minutes.

In another non-limiting embodiment, a stripping gas is not employed in the second step.

In yet another non-limiting embodiment, subsequent to the second step, the treated heavy oil is recombined with at least a portion of the first fraction. Upon recombination of at least a portion of the first fraction with the treated heavy oil, the resulting heavy oil also has a TAN that does not exceed 1.0 mg KOH/g, or is at least 50% lower than the TAN of the heavy oil prior to the treatment of the heavy oil, has an olefin content that does not exceed 1.0 wt. %, and a p-value that is at least 50% of the p-value of the heavy oil prior to the treatment of the heavy oil, or a p-value of at least 1.5.

In a non-limiting embodiment, a feedstock comprising a heavy oil is heated to a temperature that does not exceed 100° C. (AET) in order to remove any diluents and/or solvents that may be contained in the feedstock. The heavy oil then is passed to a fractionator, which may be a vacuum distillation column, which is operated at a temperature of 350° C. and a pressure of about 250 mmHg. Such vacuum distillation separates the heavy oil into a first, or light, fraction, comprised mainly of aliphatic saturates and containing less than 25% of the total acid groups of the original heavy oil, and a second, or heavy, fraction with higher aromaticity, containing at least 75% of the acid groups of the original heavy oil.

The second fraction then is passed to a decarboxylation column, which is operated at a temperature of from about 350° C. (AET) to about 380° C. (AET), and a pressure of 500 mmHg, for a period of time of from about 20 minutes to about 35 minutes. In the decarboxylation column, any naphthenic acids in the second fraction are reduced, while the olefin content is not increased significantly. In a non-limiting embodiment, the decarboxylation is effected in the absence of a stripping gas.

Thus, there is produced a stable heavy oil having an acceptable acid level and olefin content. In general, such stable heavy oil has a total acid number (TAN) that does not exceed 1.0 mg KOH/g or is at least 50% lower than the total acid number of the heavy oil prior to treatment, has an olefin content that does not exceed 1.0 wt. %, and has a p-value of at least 50% of the p-value of the heavy oil prior to treatment, or is at least 1.5.

The stable heavy oil then can be recombined with at least a portion of the first, or light fraction, or may be treated further to reduce the density and viscosity of the heavy oil, thereby making the heavy oil more pumpable and transportable. Such treatment includes heating the heavy oil and/or subjecting the heavy oil to cavitation, such as hydrodynamic and/or ultrasonic cavitation and/or subjecting the oil to visbreaking, and/or other upgrading technologies, such as thermal processes and/or hydrogen addition processes.

In a non-limiting embodiment, after the stable heavy oil is treated to reduce the density and viscosity of the heavy oil, such as by heating and/or hydrodynamic and/or ultrasonic cavitation, and/or other upgrading technologies, the stable heavy oil may be recombined with the first fraction.

The invention now will be described with respect to the drawing, wherein.

The FIGURE is a schematic of an embodiment of the method for treating a heavy oil in accordance with the present invention.

Referring now to the drawing, as shown in the FIGURE, a heavy oil in line 10 is pumped and heated and sent to fractionator 11. In general, fractionator 11 is operated at a temperature of about 300° C. in the bottom, and in any event, the temperature does not exceed 350° C., and a pressure that does not exceed 3 atm, whereby a fraction, comprised of diluents, water vapor, naphtha, and lighter ends in the form of gases, which have a boiling point less than 250° C. (AET), i.e., a 250° C. fraction, are withdrawn from fractionator 11 through line 12 and passed to knock-out drum 17. The 250° C. fraction contains no more than 25% of the naphthenic acids of the heavy oil. Off gases are withdrawn from knock-out drum 17 through line 19, while the remainder of the 250° C. fraction is withdrawn from knock-out drum 17 through line 18. Thus, a fraction that has a boiling point of less than 250° C. at atmospheric pressure (i.e., a 250° C. fraction) is separated from the heavy oil, whereby the resulting heavy oil contains a minimal amount of components that decrease the stability of the heavy oil, and further treatment to reduce the total acid number (TAN) of the heavy oil facilitates the maintenance of acceptable olefin levels.

A heavier heavy oil fraction is withdrawn from fractionator 11 through line 13 and passed to decarboxylation column 14. In general, decarboxylation column 14 is operated at a temperature that does not exceed 380° C. and a pressure that does not exceed 1 atm. The heavy oil is treated in decarboxylation column 14 for a period of time such that the naphthenic acids and other acidic components that may be present in the heavy oil are reacted, whereby the total acid number (TAN) is reduced to an acceptable level, i.e., not exceeding 1.0 mg KOH/g, or is at least 50% below the total acid number prior to the treatment of the heavy oil. In decarboxylation column 14, through the combination of heat and residence time, weak chemical bonds are broken, and acid gases such as CO₂, NOₓ, and sulfur species such as H₂S and COS are liberated. In general, the heavy oil is treated in decarboxylation column 14 for a period of time of from about 1 minute to about 60 minutes. Incondensable gases or off gases, such as CO₂, NO₂, and CO, as well as steam, are withdrawn from decarboxylation column 14 through line 15. A decarboxylated heavy oil is withdrawn from decarboxylation column 14 through line 16.

The 250° C.⁻ fraction in line 18 is passed to line 16, where it is recombined with the decarboxylated heavy oil.

The 250° C. fraction in line 18 may be recombined with the decarboxylated heavy oil in line 16 either before or after subjecting the heavy oil to further processing to reduce the density and viscosity of the heavy oil. The decarboxylated heavy oil in line 16 is a treated and stable heavy oil that has a total acid number (TAN) that does not exceed 1.0 mg KOH/g, or is at least 50% below the total acid number prior to the treatment of the heavy oil, and an olefin content that does not exceed 1.0 wt. %, and a p-value that is at least 50% of the p-value of the heavy oil prior to treatment, or a p-value that is at least 1.5.

The invention now will be described with respect to the following example; however, the scope of the present invention is not intended to be limited thereby.

### EXAMPLE

Four samples of a heavy oil having a TAN of 5.32 mg KOH/g, a bromine number (a measure of olefin content wherein a bromine number of 10 gBr2/100 g generally or approximately corresponds to an olefin content of 1.0%) of 5.72 gBr2/100 g, a p-value of 3.48, and a density of 0.9714 g/cm³, were treated in a topping step, to remove a fraction containing 3% of the total acid groups of the original oil samples, and having a resulting fraction boiling point (at atmospheric pressure) of less than 250° C. (i.e., a 250° C.⁻¹ fraction), and then the samples were treated in a second step to remove napthenic acid components therefrom.

In the topping step, each of Samples 1 and 2 were heated to 350° C. at a pressure of 252 mmHg. Sample 3 was heated to 257° C. at a pressure of 125 mmHg, and Sample 4 was heated to 276° C. at a pressure of 125 mmHg. In the reaction step, Sample 1 was heated to 367° C. at a pressure of 500 mmHg for 32 minutes, and Sample 2 was heated to 373° C. at 500 mmHg for 20 minutes. Sample 3 was heated to 385° C. at a pressure of 760 mmHg (i.e., atmospheric pressure) for 15 minutes, and Sample 4 was heated to 385° C. at a pressure of 760 mmHg for 2 minutes.

After the topping step and the second step, each of the 250° C.⁻ fractions that were separated previously from the heavy oil samples was recombined with each of the treated residue Samples 1 through 4. After the 250° C.⁻ fractions were recombined with each of the treated Samples 1 through 4, the TAN values, bromine numbers, and p-values for each of Samples 1 through 4 were measured. After the above measurements, each of Samples 1 through 4 were subjected to an additional distillation step at 300° C. under vacuum (20 mmHg pressure) to verify whether olefins were produced during the second step. After the distillation under vacuum, the TAN values, bromine numbers, and p-values again were measured. The increases in density, as measured in API gravity, of each of the recombined oil samples, also were measured. It can be seen from the results with respect to Sample 3 that the reaction severity (combination of time and temperature) was too high and thus the bromine number, which is indicative of olefin content, was higher than desired.

The TAN values, bromine numbers, p-values, and increases in density for each of Samples 1 through 4 are given in Table 1 below.

TABLE 1

| | | | | | | Density |
|---|---|---|---|---|---|---|
| | | | | Bromine | P- | Increase |
| Sample | Topping Condition | Reaction Conditions | TAN | Number | Value | (° API) |
| 1 | 350° C./252 mmHg | 367° C./500 mmHg/32 min. | 1.0 | 9.2 | 3.1 | 0 |
| 2 | 350° C./252 mmHg | 373° C./500 mmHg/20 min | 0.89 | 10.6 | 3 | 0 |
| 3 | 257° C./125 mmHg | 385° C./760 mmHg/15 min. | 0.99 | 16.69 | 2.5 | 0.05 |
| 4 | 276° C./125 mmHg | 385° C./760 mmHg/2 min. | 1.90 | 8.72 | 3.15 | 0 |

The disclosures of all patents and publications, including published patent applications, are herein incorporated by reference to the same extent as if each patent and publication were incorporated individually by reference.

It is to be understood, however, that the scope of the present invention is not to be limited to the specific embodiments described above. The invention may be practiced other than as particularly described and still be within the scope of the accompanying claims.

1-24. (canceled)

25. A process for treating a heavy oil, comprising:
(a) heating a feedstock comprising a heavy oil, said heavy oil having acid groups, to remove from said heavy oil a first fraction, wherein said first fraction contains no more than 25% of the total number of acid groups of the heavy oil, and thereby providing a second fraction, wherein said second fraction contains at least 75% of the total number of acid groups of the heavy oil; and
(b) treating said second fraction under conditions that provide a treated heavy oil that has a total acid number (TAN) that does not exceed 1.0 mg KOH/g, or a total acid number that is at least 50% lower than the total acid number (TAN) of said heavy oil prior to step (a), an olefin content that does not exceed 1.0 wt. %, and a p-value which is at least 50% of the p-value of said heavy oil prior to step (a), or a p-value of at least 1.5, wherein, in step (b), hydrogen is not added to said second fraction.

26. The process of claim 25 wherein step (a) comprises heating said feedstock comprising a heavy oil to a temperature that does not exceed 350° C. atmospheric equivalent temperature and subjecting said feedstock comprising a heavy oil to a pressure that does not exceed 3 atm.

27. The process of claim 25 wherein step (b) comprises heating said second fraction to a temperature that does not exceed 400° C. atmospheric equivalent temperature and subjecting said second fraction to a pressure that does not exceed 1 atm.

28. The process of claim 27 wherein step (b) comprises heating said second fraction to a temperature that does not exceed 385° C. atmospheric equivalent temperature and subjecting said second fraction to a pressure that does not exceed 1 atm.

29. The process of claim 28 where step (b) comprises heating said second fraction to a temperature that does not exceed 380° C. atmospheric equivalent temperature and subjecting said second fraction to a pressure that does not exceed 1 atm.

30. The process of claim 25 wherein, prior to step (a), said feedstock comprising a heavy oil is heated to a temperature that does not exceed 100° C. atmospheric equivalent temperature, thereby removing components having a boiling point of 100° C. atmospheric equivalent temperature or less from said heavy oil.

31. The process of claim 25 wherein, in step (a), said feedstock comprising a heavy oil is subjected to a pressure that does not exceed 0.66 atm.

32. The process of claim 27 wherein, in step (b), said second fraction is subjected to a pressure of about 0.66 atm.

33. The process of claim 27 wherein, in step (b), said second fraction is heated to a temperature of from about 350° C. atmospheric equivalent temperature to a temperature that does not exceed 400° C. atmospheric equivalent temperature.

34. The process of claim 27 wherein, in step (b), said second fraction is heated to a temperature that does not exceed 400° C. atmospheric equivalent temperature and subjected to a pressure that does not exceed 1 atm for a period of time of from about 1 minute to about 60 minutes.

35. The process of claim 25 wherein, in step (b), said second fraction is heated to a temperature that does not exceed 490° C. atmospheric equivalent temperature and subjected to a pressure that does not exceed 1 atm for a period of time of from about 20 minutes to about 35 minutes.

36. The process of claim 25 wherein said treated heavy oil has a p-value that is at least 75% of the p-value of the heavy oil prior to step (a), or has a p-value of at least 2.0.

37. The process of claim 25 wherein said first fraction contains no more than 10% of the total number of acid groups of the heavy oil, and said second fraction contains at least 90% of the total number of acid groups of the heavy oil.

38. The process of claim 37 wherein said first fraction contains no more than 5% of the total number of acid groups of the heavy oil, and said second fraction contains at least 95% of the total number of acid groups of the heavy oil.

39. The process of claim 38 wherein said first fraction contains no more than 3% of the total number of acid groups of the heavy oil, and said second fraction contains at least 97% of the total number of acid groups of the heavy oil.

40. The process of claim 25 wherein said treated heavy oil has an API gravity which is no more than 0.5° greater than that of said heavy oil prior to step (a).

41. The process of claim 40 wherein said treated heavy oil has an API gravity which is no more than 0.2° greater than that of said heavy oil prior to step (a).

42. The process of claim 41 wherein said treated heavy oil has an API gravity which is no more than 0.1° greater than that of said heavy oil prior to step (a).

43. The process of claim 25 wherein step (b) is performed in the absence of a stripping gas.

44. The process of claim 25, and further comprising:
recombining at least a portion of said first fraction with said treated heavy oil of step (b).

45. The process of claim 25, and further comprising:
subjecting said treated heavy oil to cavitation.

46. The process of claim 45 wherein said cavitation is hydrodynamic cavitation.

47. The process of claim 25, and further comprising:
subjecting said treated heavy oil to visbreaking.

48. The process of claim 25, and further comprising:
subjecting said treated heavy oil to a hydrogen addition process.

49. The process of claim 25 wherein, in step (a), hydrogen is not added to said feedstock.
